(19) United States
(12) Patent Application Publication
(10) Pub. No.: US 2020/0050432 A1
(43) Pub. Date: Feb. 13, 2020

(54) SYSTEM FOR PROVIDING CUSTOMIZED AND INSTANT PREVIEW OF A MOBILE APPLICATION IN NEAR REAL TIME

(71) Applicants: ANSHUMAN DAS, HALFMOON, NY (US); PRAGYAN PRIYADARSHINI, BHUBANESWAR (IN); SATYA PRAKASH DAS, BHUBANESWAR (IN); ABHINAV MOHANTY, BHUBANESWAR (IN)

(72) Inventors: ANSHUMAN DAS, HALFMOON, NY (US); PRAGYAN PRIYADARSHINI, BHUBANESWAR (IN); SATYA PRAKASH DAS, BHUBANESWAR (IN); ABHINAV MOHANTY, BHUBANESWAR (IN)

(73) Assignee: MUVI LLC, HALFMOON, NY (US)

(21) Appl. No.: 16/056,599

(22) Filed: Aug. 7, 2018

(51) Int. Cl. G06F 8/34; H04L 29/06; H04L 29/08; G06F 3/0484; G06F 3/0482

(52) U.S. Cl. CPC G06F 8/34; H04L 63/083; G06F 3/0482; G06F 3/04847; H04L 67/34

(57) ABSTRACT

Disclosed is a system for facilitating instant preview of a customized native application in near real time through a digital distribution platform on a computing device. The system includes a database to store plurality of modules, a processing unit is coupled to the database for processing the plurality of modules, a display unit displays processed plurality of modules and an input unit to input content. The modules include a registration module, an application template module, a content management module and an application module. The registration module register users on receiving a user ID and a password. The application template module allows registered users to select one default application template from multiple default application template. The content management module allows registered users to input content as per the format of the selected default template application to create a customized application. The input content and the selected template is stored in the database. The application module is distributed on digital distribution platforms to allow the user to download an application on the computing device. The downloaded application is linked to the content management module to retrieve the stored the input content from the database. Further the application module allows the user to input the user ID and the password in the downloaded application to preview the input content in the selected application template as the customized native application instantly in near real time.

### BACKGROUND OF THE INVENTION

### 1. Field of the Invention

The present invention generally relates to a system for mobile application creation platform and more specifically relates to a providing customized and instant preview of a mobile application in near real time.

### 2. Description of Related Art

Traditional mobile development requires new code to be written for each new application. This code is then submitted to a mobile application store and downloaded by the end user. Changes or updates required to traditional development call for modifications to the original code, re-submission to a mobile application store, and a re-download by the end user.

The iPHONE® mobile phone has an iOS platform. An app developer wishing to develop a mobile application for an iPHONE® mobile phone must create the mobile application using an iOS platform. The app developer also needs to download the XCODE™ integrated development environment (“IDE”). The app developer will also use the COCOA TOUCH application environment. Also, the mobile app must be certified by Apple.

If the app developer wishes to have that mobile application available for an ANDROID® phone, then the app developer must create a new mobile application using an ANDROID operating platform. The app developer will need a JAVA® development kit (“JDK”), ECLIPSE™ IDE, the ANDROID® SDK, and the ANDROID development tools plug-in.

Some of the differences between just these two platforms include multitasking, widgets, application market restrictions (Apple must certify all iOS apps), notifications, multiple hardware devices (only Apple devices use the iOS platform), editable ROMS (the iPHONE® mobile phone has a read-only memory), and setting changes.

Mobile application owners or developers have the option of checking wireframes to check design and working of the mobile application. The wireframe typically lays out the interface of the application, and presents visually the way that a user will interact with the application software. From the wireframing, the application development cycle goes through design, layout, coding, manual testing, review, automation testing and build deployment to publish.

The process is lengthy and require various professionals and tools to create and package a native application. Further, none of the existing systems allows the owners to get actual feel of the mobile application until they are published in the play store. Therefore, there is a need of a system for providing customized and instant preview of a mobile application in near real time.

### SUMMARY OF THE INVENTION

In accordance with teachings of the present invention, a system for facilitating instant preview of a customized native application in near real time through a digital distribution platform on a computing device is provided.

An object of the present invention is to provide a system that includes a database to store plurality of modules, a processing unit coupled to the database for processing the plurality of modules, a display unit to display processed plurality of modules and an input unit to input content.

The modules include a registration module, an application template module, a content management module and an application module. The registration module registers users on receiving a user ID and a password. The application template module allows registered users to select one default application template from multiple default application template.

The content management module allows registered users to input content as per the format of the selected default template application to create a customized application. The input content and the selected template is stored in the database. The application module is distributed on digital distribution platforms to allow the user to download an application on the computing device.

The downloaded application is linked to the content management module to retrieve the stored input content from the database. Further, the application module allows the user to input the user ID and the password in the downloaded application to preview the input content in the selected application template as the customized native application instantly in near real time.

The display unit to display processed plurality of modules. The input unit to input content into the content management module and the registration module. The input unit allows selection of the template from the application template module.

Another objective of the present invention is to provide the system with an application creation module linked to the application template module and content management module for creating a ready-to-publish application for publishing on digital distribution platforms. The ready-to-publish application includes the selected default application template with the input content, further the application creation module sends the ready-to-publish application over the communication network.

Another objective of the present invention is to provide the system with a content library module for allowing registered users to perform at least one of: add content; and import content through a communication network. Further, the database stores plurality of content. The content management module allows the registered user to download the uploaded content in the database in offline mode. Further, the customized native application allows the registered user to access the downloaded content in near real time in the offline mode.

Another objective of the present invention is to provide the content management module for allowing the users to update the input content. Further, the customized native application displays the updated input content on refreshing in near real time. Further, the application template module includes a menu module to allow registered users to create customized menu for displaying in the selected default application template.

Another objective of the present invention is to provide the application template module with an UI color scheme module to allow the user to select color scheme using a flexi color palette selector. The UI color scheme is adapted by the selected mobile application template.

Further features and advantages of the present invention, as well as the structure and operation of various embodiments of the present invention, are described in detail below with reference to the accompanying drawings.

### BRIEF DESCRIPTION OF DRAWINGS

FIG. 1 illustrates a block diagram of a system for providing instant preview of a customized mobile application in near real time in accordance with a preferred embodiment of the present invention;

FIG. 2 is a screenshot showing of the application template module in accordance with an exemplary embodiment of the present invention;

FIG. 3 is a screenshot showing of the content management module in accordance with an exemplary embodiment of the present invention;

FIG. 4 is a screenshot showing of an application module previewing of the input content in the selected default application template;

FIG. 5 is a screenshot showing of a menu module in accordance with another preferred embodiment of the present invention; and

FIG. 6 illustrates a screenshot showing of a creation module in accordance with another preferred embodiment of the present invention.

### DETAILED DESCRIPTION OF DRAWINGS

While this technology is illustrated and described in a preferred embodiment, a system for providing instant preview of a customized mobile application in near real time may be produced in many different configurations, forms, and computer languages. This is depicted in the drawings and will be described in detail, as a preferred embodiment of the invention, with the understanding that the present disclosure is to be considered as an exemplification of the principles of the invention and the associated functional specifications for its construction. It is not intended to limit the invention to the embodiment illustrated. Those skilled in the art will envision many other possible variations within the scope of the technology described herein.

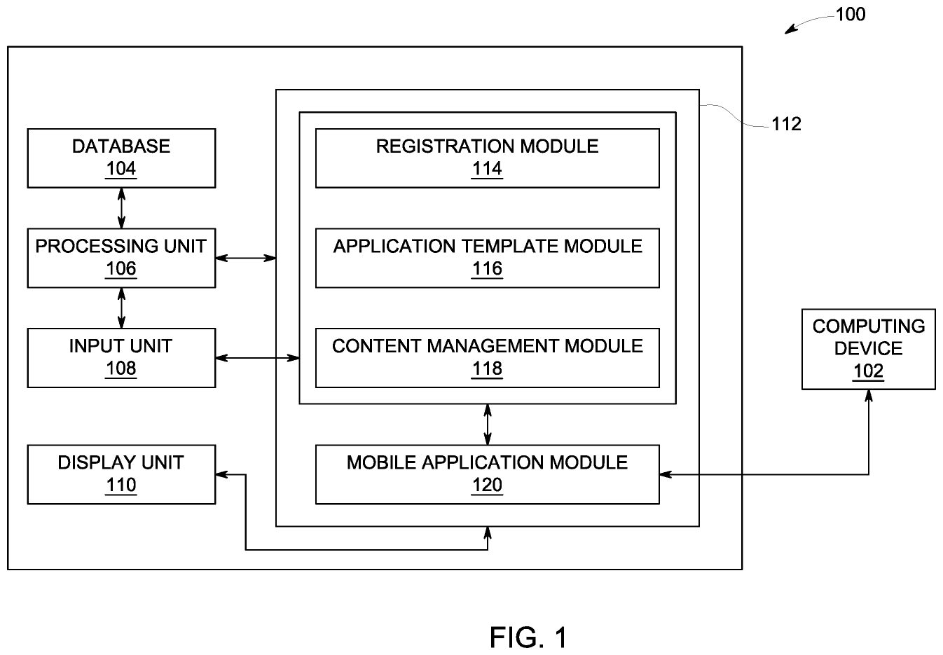

FIG. 1 illustrates a block diagram of a system 100 for providing instant preview of a customized mobile application in near real time in accordance with a preferred embodiment of the present invention. The system 100 for providing instant preview of a customized mobile application in near real time through a digital distribution platform on a computing device 102.

The system 100 includes a database 104, a processing unit 106, an input unit 108 and a display unit 110. The database 104 stores plurality of modules 112. The database 104 may be either local or on cloud. Examples of the database 104 include but not limited to My SQL, Dynamo, Mongo etc.

The processing unit 106 is coupled to the database for processing the plurality of modules 112. The plurality of modules 112 include a registration module 114, an application template module 116, a content management module 118 and a mobile application module 120.

The registration module 114 register users on receiving a user ID and a password. In another preferred embodiment of the invention, the user may register themselves by providing details like first name, last name, social media account, email Id, Phone number etc.

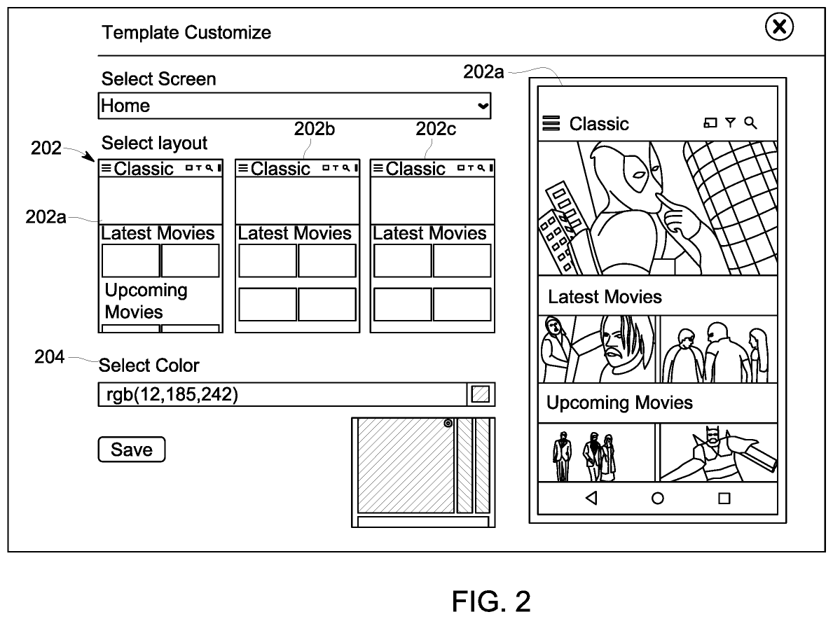

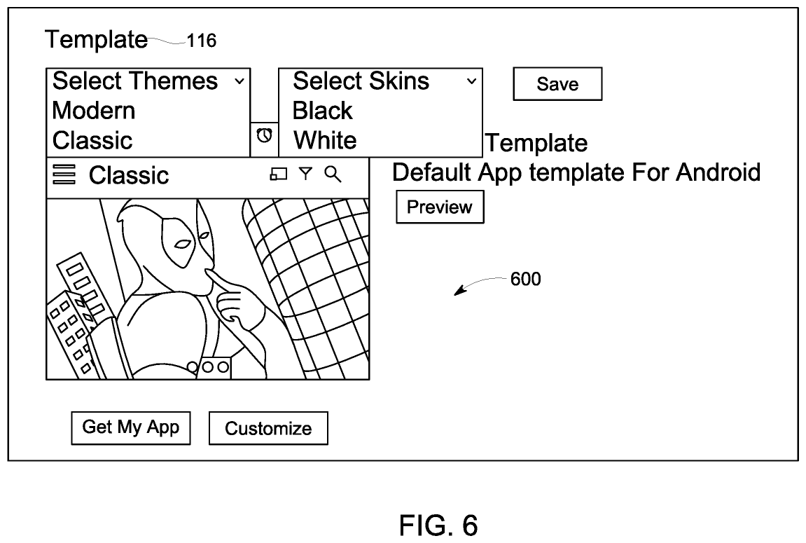

The application template module 116 allows registered users to select one default mobile application template from multiple default mobile application template. The application template module 116 is explained in detail in conjunction with FIG. 2 and FIG. 6 of the present invention.

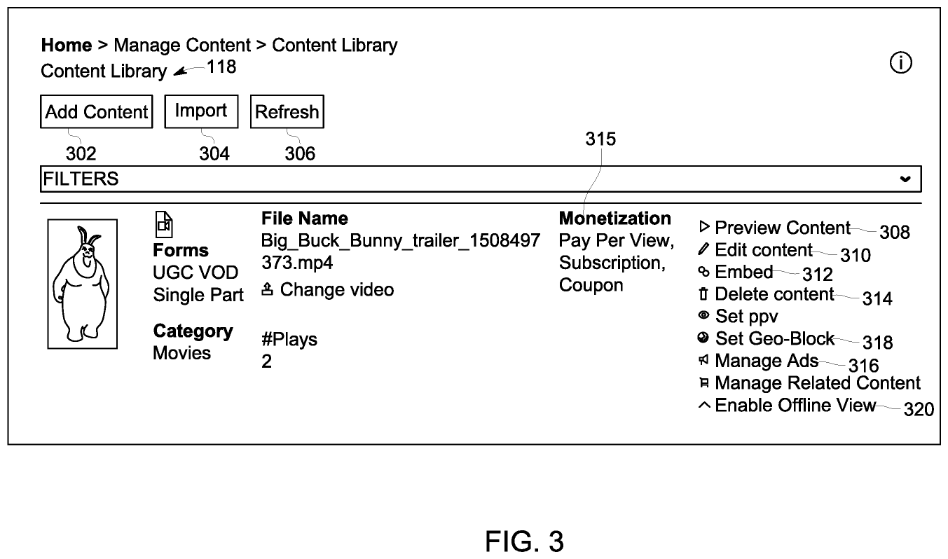

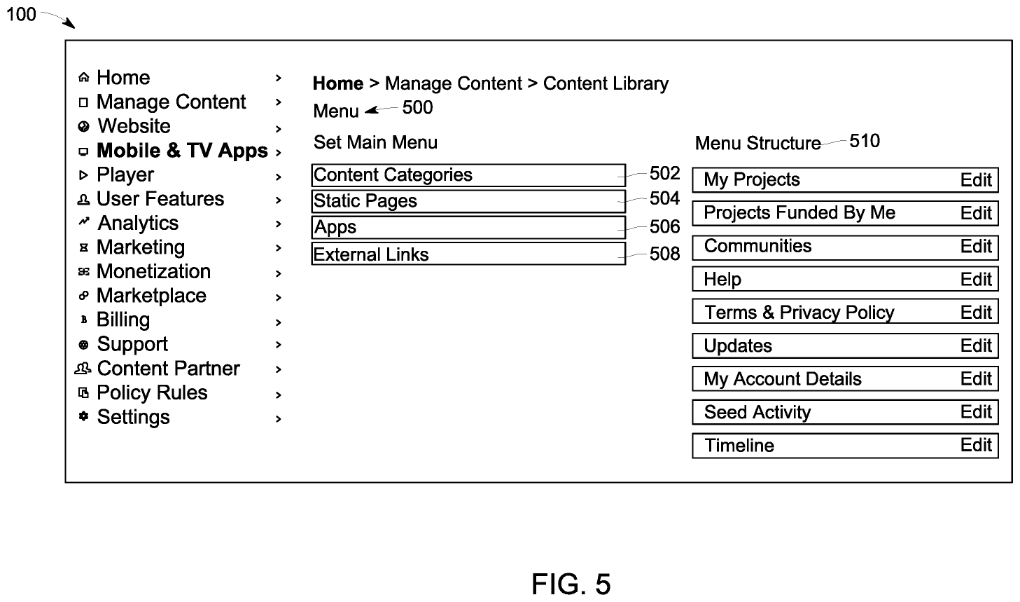

The content management module 118 for allowing registered users to input content as per the format of the selected default template mobile application to create a customized mobile application. The input content and the selected template is stored in the database. The content management module 118 is explained in detail in conjunction with FIG. 3 and FIG. 5 of the present invention.

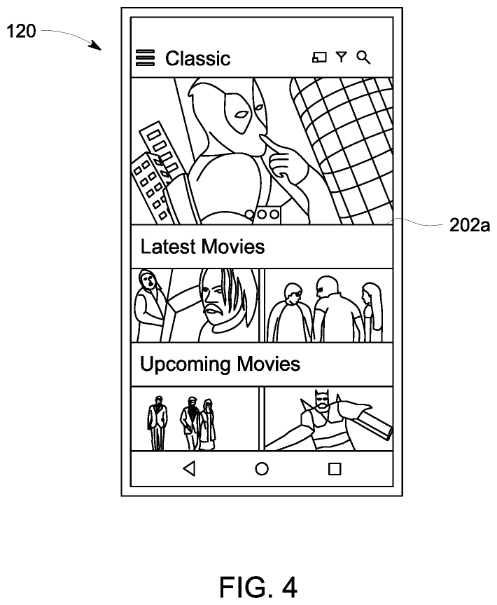

The mobile application module 120 is distributed on digital distribution platforms allow the user to download a mobile application linked to the content management module on the computing device 102. Further, the mobile application module 120 allows the user to input the user ID and the password to preview the input content in the selected mobile application template as a customized native mobile application instantly in near real time. The mobile application module 120 is explained in detail in conjunction with FIG. 4 of the present invention.

The input unit 108 allows the user to input content into the content management module 118 and the registration module 114. Further, the input unit 108 allows the user to select one of the template from the application template module. Examples of the input unit 108 include but not limited to a keyboard, a mouse, a stylus, and other similar input unit 108. The display unit 110 displays processed plurality of module 112. Examples of the display unit 110 include but not limited to LED, LCD, OLED, screens of smart TV, smart watch, tablet, phablet, smartphone etc.

FIG. 2 is a screenshot showing of the application template module 116 in accordance with an exemplary embodiment of the present invention. The application template modules 116 displays various layouts 202 such as 202a, 202b, 202c. The application template module 116 further displays a preview of the selected layout 202a with a dummy/default content. The examples of application template module 116 include but not limited to mobile application, website application, CRM application, TV application etc.

In the exemplary embodiment as show in FIG. 2 of the present invention, the layouts 202 provide various option to present the content in the mobile application. The layouts 202 may present with various options such as different types of grids, different number of columns, and different number of rows. It would be readily apparent to those skilled in the art that various type of layouts 202 may be envisioned without deviating from the scope of the present invention.

In the exemplary embodiment as show in FIG. 2 of the present invention, the content is a combination of audio and video file i.e. movies. However, it would be readily apparent to those skilled in the art that the content may be either audio or video or photos or combination of each of them.

In another preferred embodiment of the present invention, the system 100 further includes a UI color scheme module 204 to allow the user to select color scheme using a flexi color palette selector 206. The UI color scheme is adapted by the selected mobile application template such as the application template 202a.

In another preferred embodiment of the present invention, the application template module 116 allows users to update the selected default application template. Further, the customized native application retrieved from the application module (120 shown in FIG. 1 and FIG. 4) displays the input content in the updated selected default application template on refreshing in the near real time.

FIG. 3 is a screenshot showing of the content management module 118 in accordance with an exemplary embodiment of the present invention. The content management module 118 allows adding content through an add content tab 302, importing content through an import tab 304 either from local database or a cloud, and allows refreshing of content through a refresh tab 306.

The registered user is able to upload or add content such as audio, video, photos or a combination of audio, video and photos. The registered user is able to upload content in various format such as .PNG, .JPEG, .MP4, .MP3, .PDF, SVG, .AAC, .BMP, .HLS, .MPEG-DASH etc. It would be readily apparent to those skilled in the art that various format of content may be envisioned without deviating from the scope of the present invention.

The content management module 118 further allows the user to preview the added or uploaded content in the selected default application template using a preview content tab 308. Further, the content management module 118 further allows the user to edit content 310, embed 312 a hyperlink/weblink, and delete 314 a content etc.

In another preferred embodiment of the present invention, the content management module 118 further includes ad management module 316 to allow registered users to create advertisements to be viewed along the content through the application template. The type of advertisements includes but not limited to server side advertisement, client side advertisement, ad tagging, pay per click, ad exchange, social media campaigns etc. It would be readily apparent to those skilled in the art that various types of advertisements may be enabled in the ad management module 316 without deviating from the scope of the present invention.

Further in another preferred embodiment of the present invention, the content management module 118 further includes a monetization module 315 to allow registered users to access content. The registered users may access content through various payment modes such as pay per view, vouchers, subscription, coupons, credit etc. It would readily apparent to those skilled in the art that various types of payment modes for accessing content may be envisioned without deviating from the scope of the present invention.

Further in another preferred embodiment of the present invention, the content management module 118 further includes a set-geo block 318 to restrict the access to mobile application and advertisements to specified countries or geo-locations. It would be readily apparent to those skilled in the art that users are able to select one or more geo-locations without deviating from the scope of the present invention.

Further in another preferred embodiment of the present invention, the content management module 118 allows the registered user to download the uploaded content in the database in offline mode 320. Further, the customized native application retrieved from the mobile application module (120, explained in FIG. 1 and FIG. 4) allows the registered user to access the downloaded content in near real time in the offline mode.

Further in another preferred embodiment of the present invention, the database stores plurality of content. The content management module 118 further allows the registered user to manipulate the input content in the database. Further, the customized native application retrieved from the mobile application module (120 explained in FIG. 1 and FIG. 4) allows the registered user to access the manipulated content in the near real time.

Examples of the manipulation includes but not limited to offline viewing, casting, DRM, translation, device restrictions etc. The content management module 118 allows the user to download and consume the input content in offline mode without internet. Further, the content management module 118 allows the user to download the input content to a mobile device.

The content management module 118 further allows the user to cast the content to a television through airplay or chromecast. The content management module 118 further enables the input content to become available to supported screens. The content management module 118 further enables DRM protection for each content in order to improve security and piracy threats through downloads. In an exemplary embodiment of the present invention, the content management module 118 may secure the input content as per Hollywood approved DRM norms.

The content management module 118 further provides options to translate the content in various languages in order to deliver their content with multi-language audience. Furthermore, the content management module 118 may set device and stream restrictions to the content, so the input content may be consumed by permitted number of devices and users.

FIG. 4 is a screenshot showing of the application module 120 previewing of the input content in the selected default application template 202a. With reference to FIG. 1, the application module 120 is linked to the content management module to retrieve and display content in near real time on the selected default application template 202a.

In a preferred embodiment of the present invention, a tokenized JSON based authentication is implemented to handshake between content management module and application module to ensure security over tradition API authentication. Upon entering the username and password in the application downloaded from the application module, the application is rendered based on the JSON data received in the content management module, making all data dynamically driven from the backend.

However, it would readily apparent to those skilled in the art that various other processes may be envisioned to link application module to handshake with the content management module such as XML, GSON, BSON, Jackson, and any other similar stateless serialized token based authentication may be envisioned without deviating from the scope of the present invention.

The registered users are able to download the application module 120 from the digital distributed platforms such as Android app, iOS app, Android TV App, Fire TV App, Apple TV App, Samsung, LG, Xbox, Playstation, Roku and other similar IOT based devices etc. It would be readily apparent to those skilled in the art that application module 120 may be downloaded from various digital distributed platforms without deviating from the scope of the present invention.

In an exemplary embodiment of the present invention as shown in FIG. 4, the downloaded application module from the digital distribution platform is a mobile application displaying the content uploaded in the content management module in near real time, thus creating a customized native application instantly in near real time on the application module.

The customized native application displays the content inputted in the content management module in the selected application template in near real time. The customized native application is updated in near real time simultaneously to updation/refresh of the content management module.

FIG. 5 is a screenshot showing of a menu module 500 in accordance with another preferred embodiment of the present invention. The system 100 further includes a menu module 500 to allow registered users to create customized menu for displaying in the selected default application template.

The menu module 500 allows the users to set the main menu in various categories such as content categories 502, static pages 504, apps 506 and external links 508. Further, the menu module allows the user to create menu structure 510 to be displayed on the selected default application template. Furthermore, the menu structure 510 allows the user to select option of showing the menu either in horizontal or vertical position.

In an exemplary embodiment as shown in FIG. 5, the menu structure 510 includes my projects, projects funded by me, communities, help, terms and privacy policy, updates, my account details, send activity and timeline. It would be readily apparent to those skilled in the art that various categories may be envisioned under main menu and menu structure 510 without deviating from the scope of the present invention.

FIG. 6 illustrates a screenshot showing of a creation module 600 in accordance with another preferred embodiment of the present invention. With reference to FIG. 1, the plurality of modules (112, shown in FIG. 1) further includes an application creation module 600 which is linked to the application template module 116 and content management module (118, shown in FIG. 1 and FIG. 3) for creating a ready-to-publish application for publishing on digital distribution platforms.

The ready-to-publish application includes the selected default application template with the input content. The application creation module sends the ready-to-publish application over the communication network. In a preferred embodiment of the present invention, the application creation module sends the ready-to-publish application as a weblink in an email.

However, it would be readily apparent to those skilled in the art that the application creation may send the ready-to-publish application in any publishing format based upon the digital distribution platform and in any other communication way such as SMS, MMS, Whatsapp, and other similar types of internet based messengers.

The present invention offers various advantages such as saving time to create the mobile application. Further provide the mobile application with zero coding efforts. Furthermore, the present invention allows the user to instantly preview the desired content in the desired template without creating frameworks, coding and deployment.

Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A system for providing instant preview of a customized native application in near real time through a digital distribution platform on a computing device, the system comprising:
a database to store plurality of modules;
a processing unit coupled to the database for processing the plurality of modules, wherein the plurality of modules comprising:
a registration module for registering users on receiving a user ID and a password;
an application template module allows registered users to select one default application template from multiple default application template;
a content management module for allowing registered users to input content as per the format of the selected default template application to create a customized application, wherein the input content and the selected template is stored in the database; and
an application module distributed on digital distribution platforms allow the user to download an application on the computing device, wherein the downloaded application is linked to the content management module to retrieve the stored input content from the database, further the application module allows the user to input the user ID and the password in the downloaded application to preview the input content in the selected application template as the customized native application instantly in near real time;
a display unit to display processed plurality of modules; and
an input unit to input content into the content management module and the registration module, further the input unit allows selection of the template from the application template module.

2. The system according to claim 1, wherein the plurality of modules further comprising an application creation module linked to the application template module and content management module for creating a ready-to-publish application for publishing on digital distribution platforms, wherein the ready-to-publish application comprising the selected default application template with the input content, further the application creation module sends the ready-to-publish application over the communication network.

3. The system according to claim 1 wherein the plurality of modules further comprising a content library module for allowing registered users to perform at least one of: add content; and import content through a communication network.

4. The system according to claim 1 wherein the database stores plurality of content, wherein the content management module allows the registered user to download the uploaded content in the database in offline mode, further wherein the customized native application allows the registered user to access the downloaded content in near real time in the offline mode.

5. The system according to claim 1 wherein the database stores plurality of content, wherein the content management module allows the registered user to manipulate the input content in the database, further wherein the customized native application allows the registered user to access the manipulated content in the near real time.

6. The system according to claim 1 wherein the content management module allows users to update the input content, further wherein the customized native application displays the updated the input content on refreshing in near real time.

7. The system according to claim 1 wherein the application template module allows users to update the selected default application template, further wherein the customized native application displays the input content in the updated selected default application template on refreshing in near real time.

8. The system according to claim 1 wherein the application template module further comprising a menu module to allow registered users to create customized menu for displaying in the selected default application template.

9. The system according to claim 1 wherein the application template module further comprising a UI color scheme module to allow the user to select color scheme using a flexi color palette selector, wherein the UI color scheme is adapted by the selected mobile application template.
